(19) United States
(12) Patent Application Publication
(10) Pub. No.: US 2013/0037675 A1
(43) Pub. Date: Feb. 14, 2013

(54) SUPPORTING DEVICE FOR SUPPORTING A LOAD TO STRUCTURE

(71) Applicants: Inge-Svenn Nærø, Alesund (NO); Severin Åkervik Ulstein, Alesund (NO)

(72) Inventors: Inge-Svenn Nærø, Alesund (NO); Severin Åkervik Ulstein, Alesund (NO)

(73) Assignee: THEMIS CREATE AS, >Ålesund (NO)

(21) Appl. No.: 13/579,427

(22) PCT Filed: Feb. 17, 2011
(86) PCT No.: PCT/NO2011/000057

§ 371 Date: Oct. 30, 2012

(30) Foreign Application Priority Data
Feb. 17, 2010 (NO) 20100235

(51) Int. Cl. F16M 13/02; B63B 27/24

(52) U.S. Cl. 248/309.1

(57) ABSTRACT

The invention relates to a supporting device for supporting a load (2) to a structure (4), comprising a body, a movement restraining device and an actuating device. The body (3) comprises a first abutment surface (30a) and a second abutment surface (31a), where the first and second abutment surfaces (30a, 31a) are at least partially faced towards each other forming parts of a mainly U-shaped surface (32) of the body (3). The body also comprises a load supporting device (33) for supporting the load (2) in relation to the body (3). The movement restraining device (6) is movably connected to the body (3) between a locked and unlocked position, wherein the movement restraining device (6) is configured to restrain the movement of the body (3) in relation to structure in its locked position. The actuating device (7) is movably connected to the body (3) and to the movement restraining device (6), for actuating the movement restraining device (6) between its locked and unlocked positions. A connection interface (90) is provided in the second end area (7b) of the actuating device (7), where the connection interface (90) is configured to be engaged with a remotely controlled actuator (9).

### FIELD OF THE INVENTION

The present invention relates to a supporting device for supporting a load to a structure and a supporting device for supporting a load.

### BACKGROUND OF THE INVENTION

During offshore lifting operations, such as operations related to oil and/or gas production, there is a need to lift a supporting device for supporting a load to a structure. For example, the load may be a hose which is to be connected between a fixed platform and a movable vessel located near the fixed platform for transferring fluids between the platform and the vessel. A first end of the hose is connected to a fluid transferring system of the platform, while a second end of the hose is fastened to a supporting device, the supporting device being adapted to be connected to a structure of the vessel. When the supporting device is supported to the structure of the vessel, the hose is connected to a fluid transferring system of the vessel, and fluid transfer can be performed through the hose. After the fluid transfer, a disconnection of the supporting device from the structure of the vessel must be performed before the vessel can leave the platform.

There are several problems related to such operations. Due to security issues, there must be a minimum distance between the fixed platform and the vessel, to avoid collision. Hence, a crane is often used to lift the supporting device from the platform to the vessel. It should be noted that the crane is normally disengaged from the supporting device during fluid transfer, since the fluid transfer may take long time and the crane is needed for other operations in the meantime. The crane must therefore be engaged with the supporting device again before disconnection of the supporting device from the structure.

Waves, sea currents and wind influence the vessel and also the crane wire to move, so both the connection operation of the supporting device to the structure and the disconnection operation of the supporting device from the structure may be difficult for the crane operator. It should be noted that no manual work is normally allowed needed near the structure of the vessel during connection/disconnection, since the supporting device when hanging from the crane may cause severe injuries to personnel.

It should also be noted that the disconnection operation is considered most crucial. If a connection operation has been performed, and the weather conditions gets worse during the fluid transfer, the vessel may be required to disconnect from the platform and increase the distance to the platform immediately. In such situations, it is important that the crane operator is able to perform a fast engagement between the crane wire and the supporting device and also a fast disconnection of the supporting device from the structure, so that the vessel is free to move further away from the platform.

Some of these problems also arise in other applications related to lifting operations of a supporting device for supporting a load to a structure, for example lifting operations by means of helicopters or other lifting devices. Also here it is necessary to achieve engagement and disengagement between a lifting wire from the helicopter to a load supporting device, where manual work might be unwanted or not available.

The object of the invention is to provide a supporting device for supporting a load to a structure, where the above disadvantages are avoided. More specifically, it is an object to achieve a supporting device which is easy to connect to and disconnect from a structure. Moreover, it is an object to enable an easy engagement and disengagement of a lifting wire to/from the supporting device without the need of manual work.

In many applications, manual work is required for connecting a lifting wire to a load. The object of the present invention is also to provide a general solution for enabling an easy engagement and disengagement of a lifting wire to a load without the need of manual work.

### SUMMARY OF THE INVENTION

The present invention relates to a supporting device for supporting a load to a structure, comprising:
a body comprising a first abutment surface and a second abutment surface, where the first and second abutment surfaces are at least partially faced towards each other forming parts of a mainly U-shaped surface of the body, where the body further comprises a load supporting device for supporting the load in relation to the body;
a movement restraining device movably connected to the body between a locked and unlocked position, wherein the movement restraining device is configured to restrain the movement of the body in relation to structure in its locked position;
an actuating device comprising a first end area and a second end area opposite of the first end area, where the first end area is movably connected to the body and to the movement restraining device, for actuating the movement restraining device between its locked and unlocked positions;
a connection interface provided in the second end area of the actuating device, where the connection interface is configured to be engaged with a remotely controlled actuator.

In one aspect, the movement restraining device comprises at least one first end area, where a first section of the first end area is rotatably connected to the body around a first axis.

In one aspect, the movement restraining device comprises at least one second end area, opposite of the first end area, where the second end area is configured to restrain the movement of the body in relation to the structure in its locked position.

In one aspect, a first section of the first end area of the actuating device is rotatably connected to the body around a second axis, parallel to the first axis.

In one aspect, a second, distal section of the first end area of the movement restraining device and a second, distal section of the first end area of the actuating device are rotatably connected to each other around a third axis, where the third axis is parallel displaceable with respect to the first and second axis.

In one aspect, movement of the second end of the actuating device in a direction away from the legs of the U-shaped surface provides that the movement restraining device is moved to its unlocked position and where a movement of the second end of the actuating device in a direction towards the legs of the U-shaped surface provides that the movement restraining device is moved to its locked position.

In one aspect, the connection interface comprises first and second rails configured for receiving a first actuator element of the remotely controlled actuator between the first and second rails.

In one aspect, the connection interface further comprises a releasable locking device for releasably locking the remotely controlled actuator to the connection interface.

In one aspect, the device further comprises at least one guiding device for guiding the remotely controlled actuator towards the connection interface.

In one aspect, the device comprises a first guiding device connected to the first rail and a second guiding device connected to the second rail.

In one aspect, the distance between the first and second rails is larger than the diameter of the first actuator element for allowing the first actuator element to pass between the rails, and where the distance between the first and second rails is smaller than the diameter of a first stopping device located below the first actuator element of the remotely controlled actuator.

### DETAILED DESCRIPTION

In the following, embodiments of the invention will be described in detail with reference to the enclosed drawings, where:

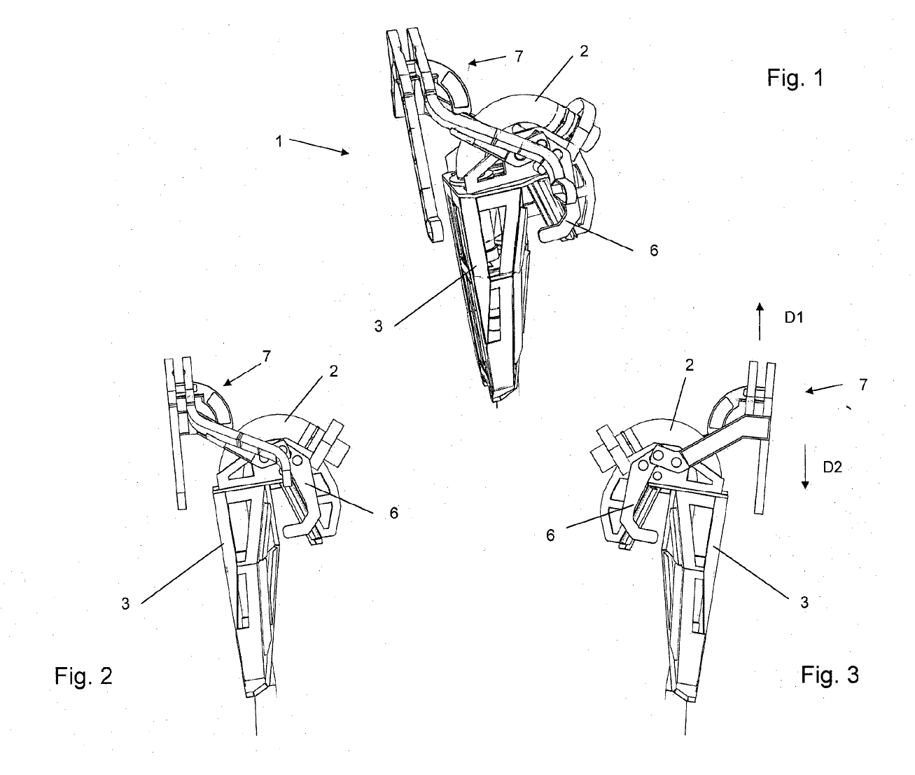

FIG. 1 illustrates a perspective view of a first embodiment where the load is a hose;

FIG. 2 illustrates a side view of the embodiment in FIG. 1;

FIG. 3 illustrates a side view of the embodiment in FIG. 1 from the opposite side;

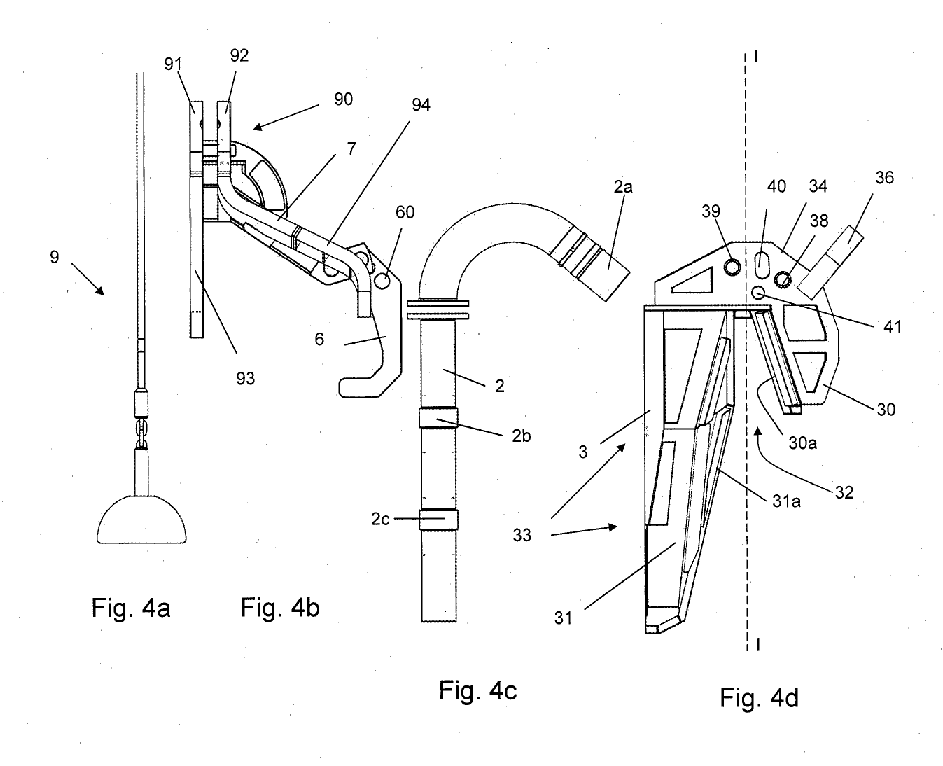

FIGS. 4a-d illustrate an exploded side view, where:

FIG. 4a illustrates a remotely controlled actuator used together with the embodiment in FIG. 1;

FIG. 4b illustrates the movement restraining device and the actuating device of the embodiment of FIG. 1;

FIG. 4c illustrates a hose being supported by the device;

FIG. 4d illustrates the body of the embodiment of FIG. 1;

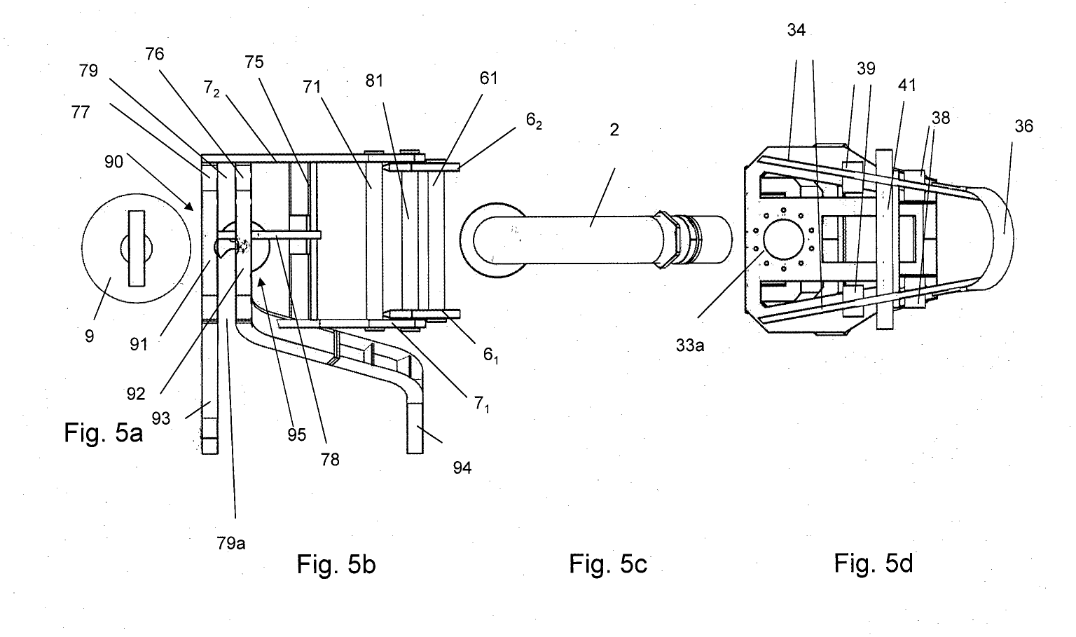

FIGS. 5a-d illustrate an exploded top view corresponding to FIG. 4a-d above;

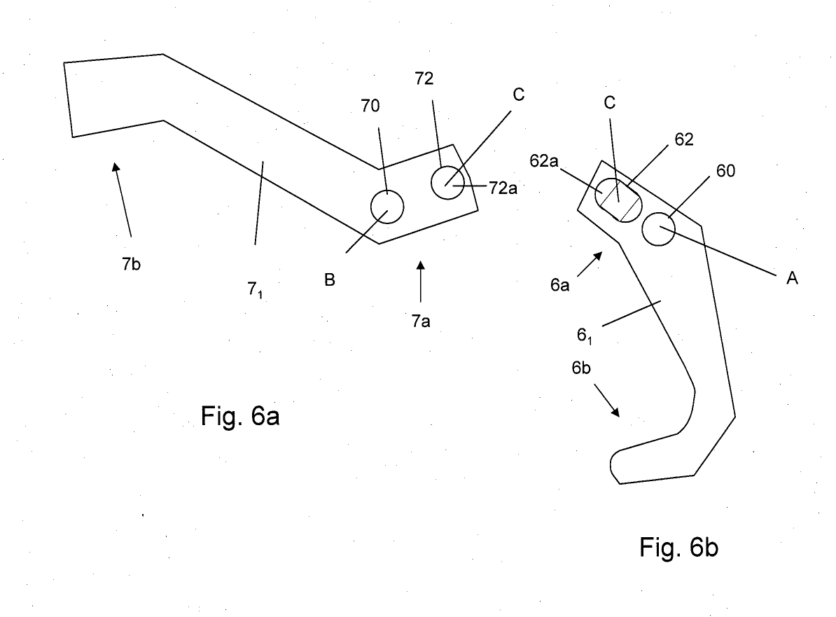

FIGS. 6a and 6b illustrate parts of the actuating device and the movement restraining device respectively, separated from each other;

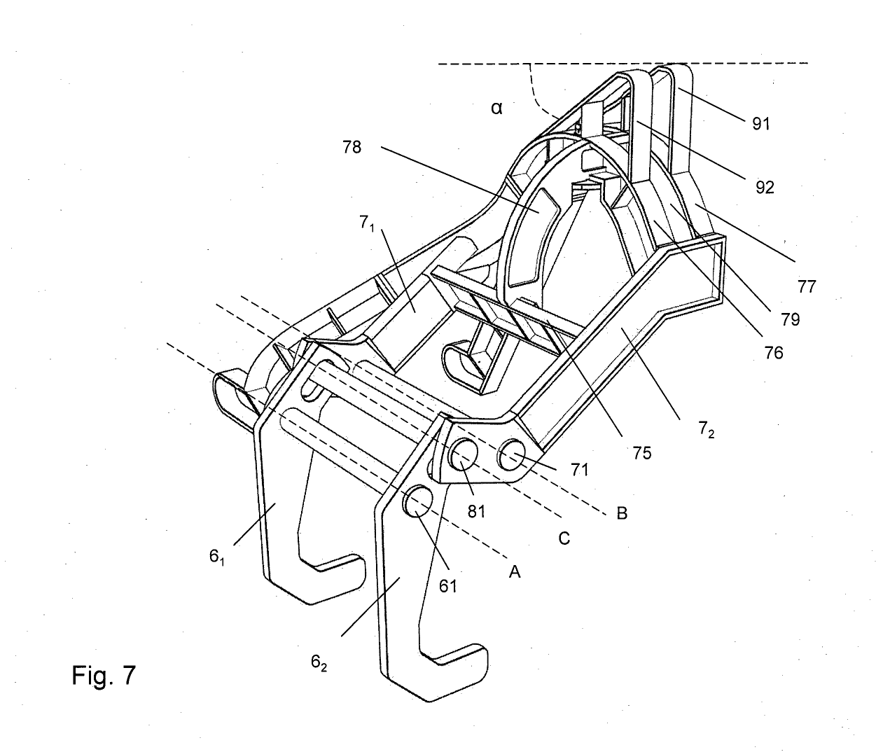

FIG. 7 illustrates a perspective view of the actuating device and the movement restraining device connected to each other (corresponding to FIGS. 4b and 5b);

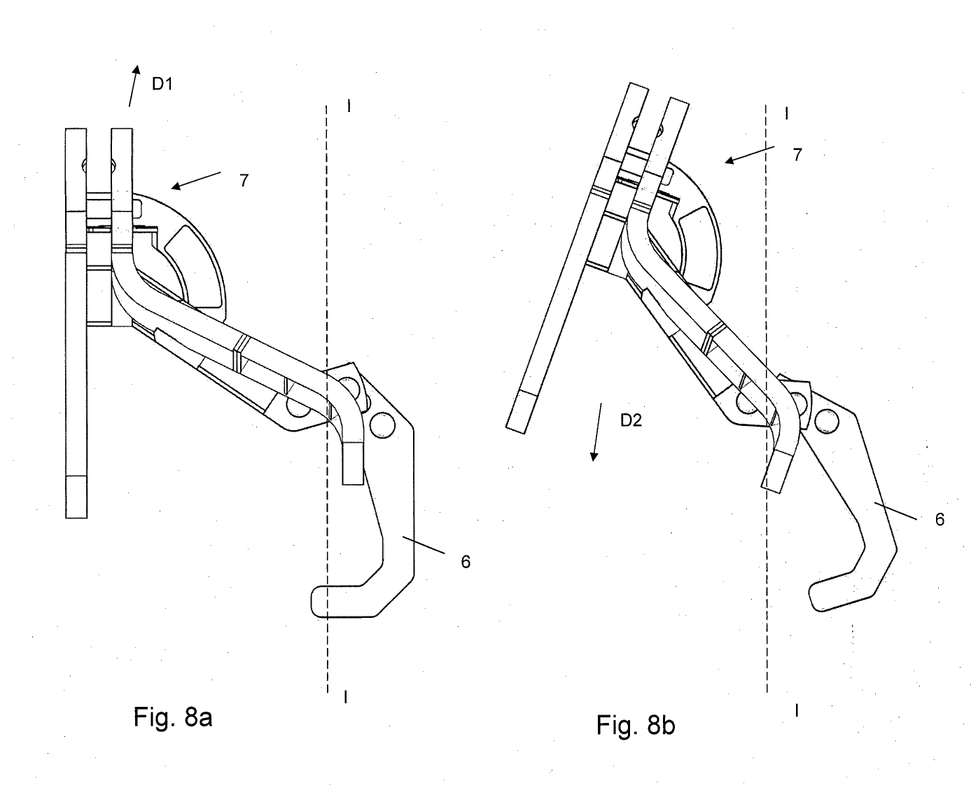

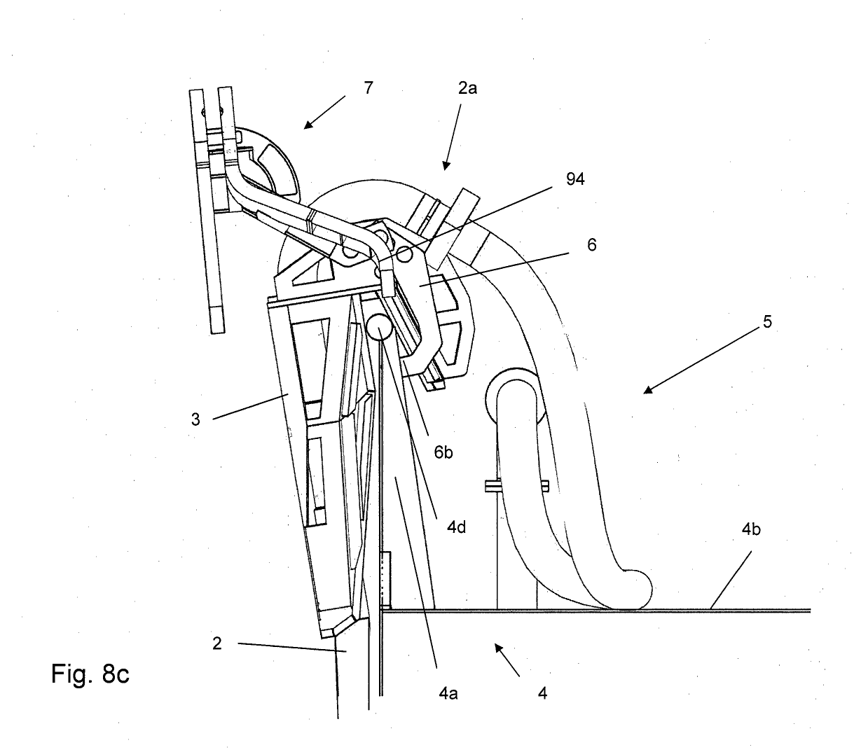

FIG. 8a illustrates a side view of the actuating device and the movement restraining device in a locked position;

FIG. 8b illustrates a side view of the actuating device and the movement restraining device in an unlocked position;

FIG. 8c illustrates a side view of the supporting device fixed to a structure (i.e. locked position);

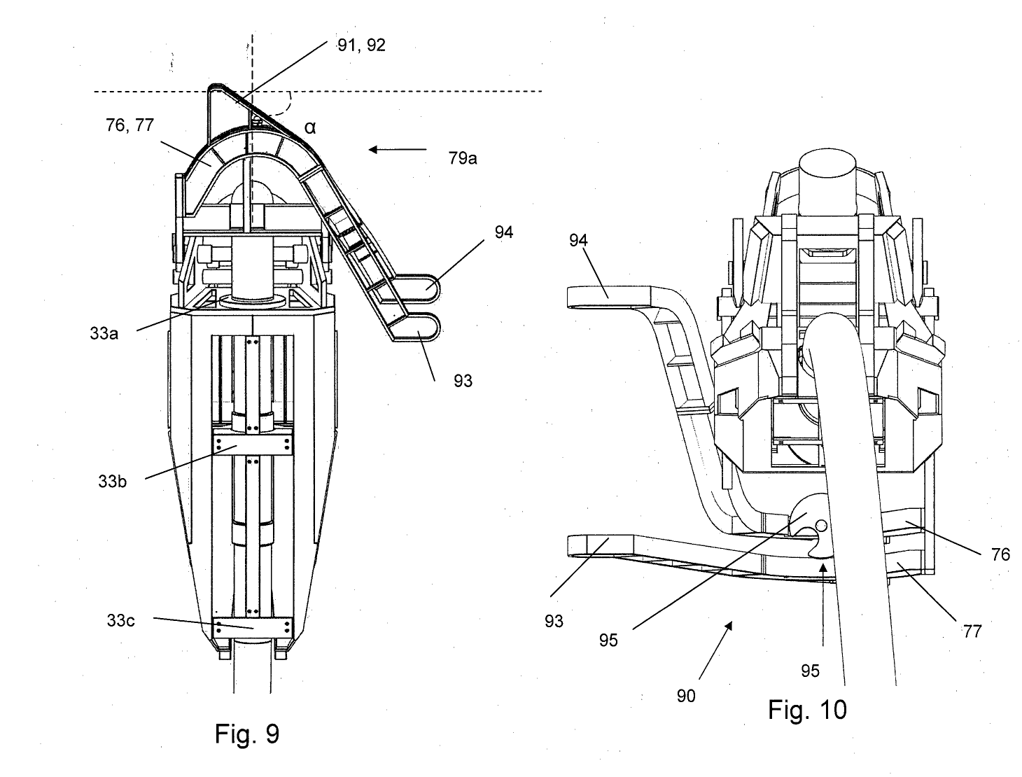

FIG. 9 illustrates a rear view of the embodiment in FIG. 1;

FIG. 10 illustrates a bottom view of the embodiment of FIG. 1;

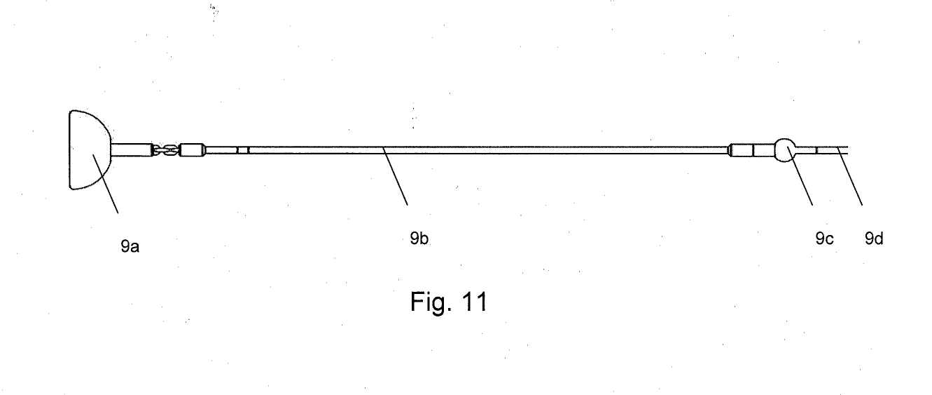

FIG. 11 illustrates the remotely controlled actuator of FIGS. 4a and 5a;

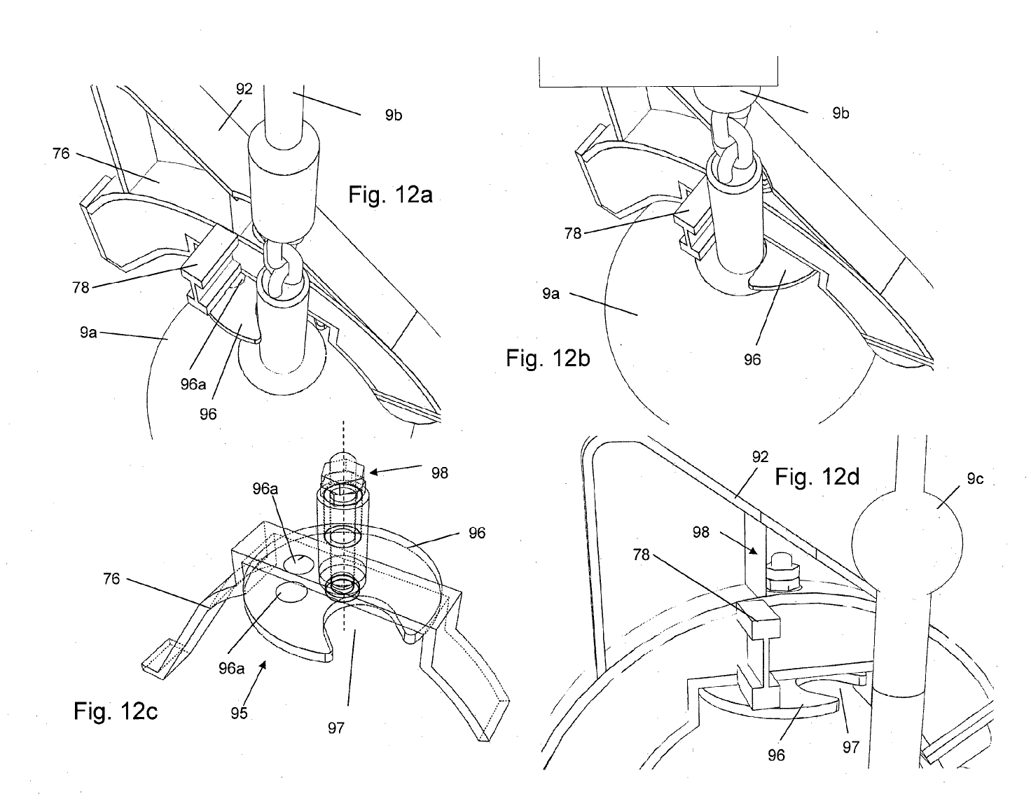

FIG. 12a illustrates the function of the releasable locking device, where the remotely controlled actuator is received in the recess;

FIG. 12 b illustrates the function of the releasable locking device in its locked position;

FIG. 12c illustrates a semitransparent perspective view of the releasable locking device;

FIG. 12d illustrates the function of the releasable locking device, where the remotely controlled actuator is released.

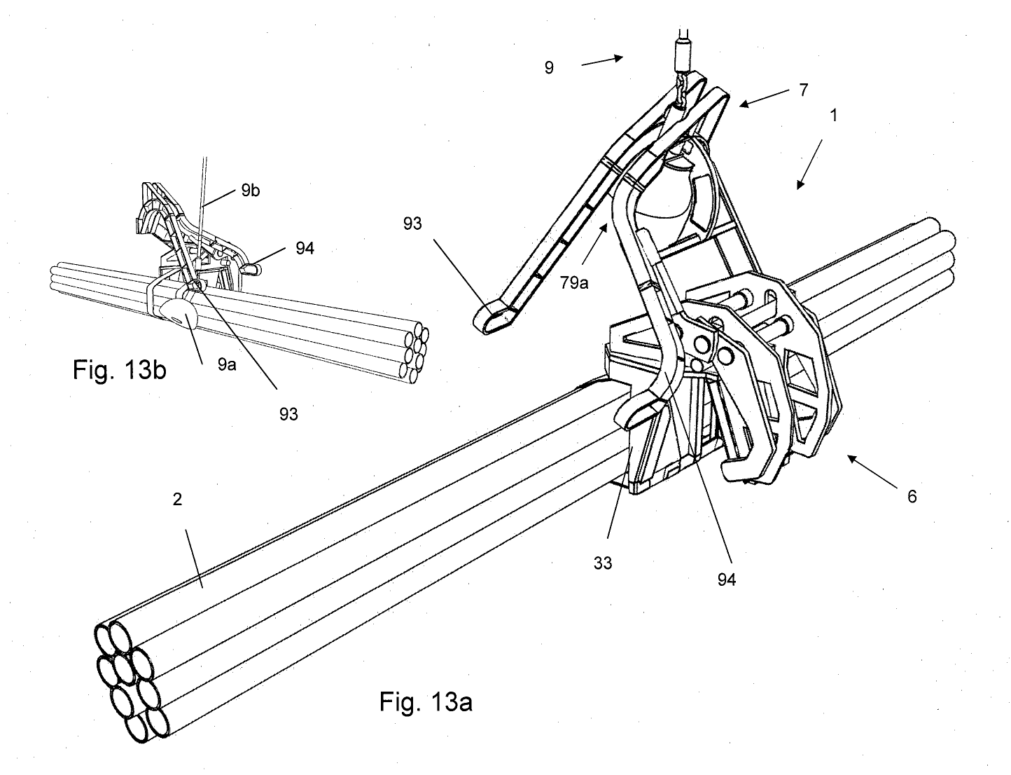

FIGS. 13a and 13b illustrate a second embodiment where the load is a pipe stacking frame;

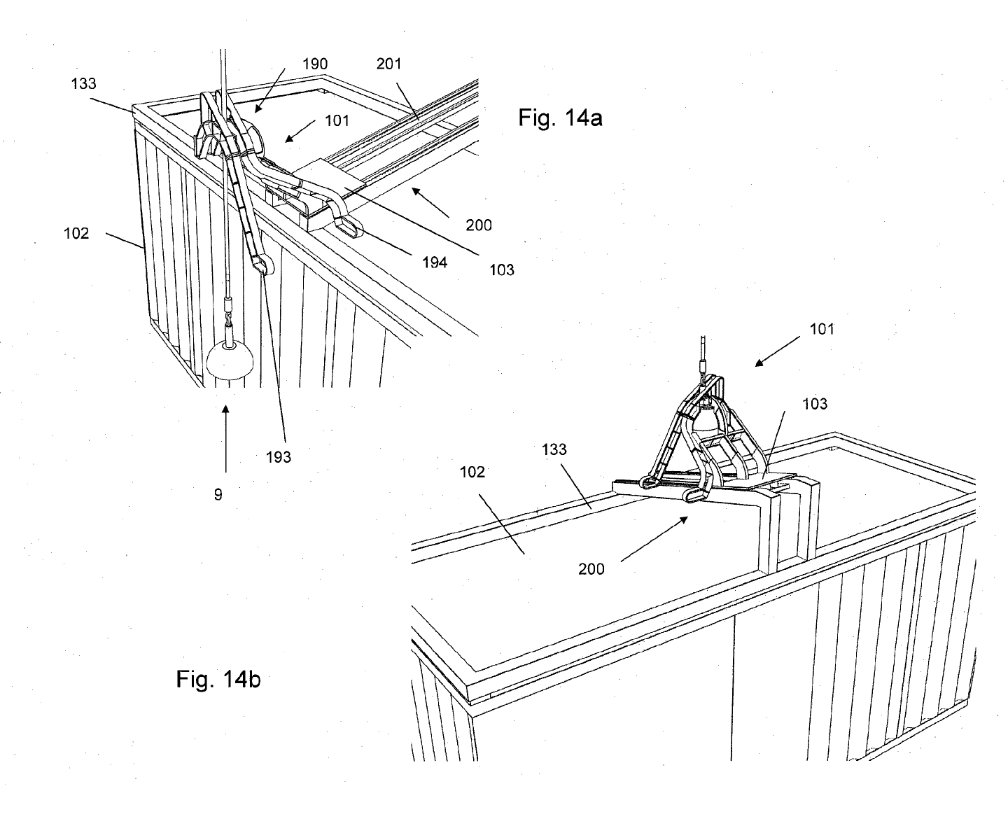

FIGS. 14a and 14b illustrate the principle of the present invention used for lifting a container;

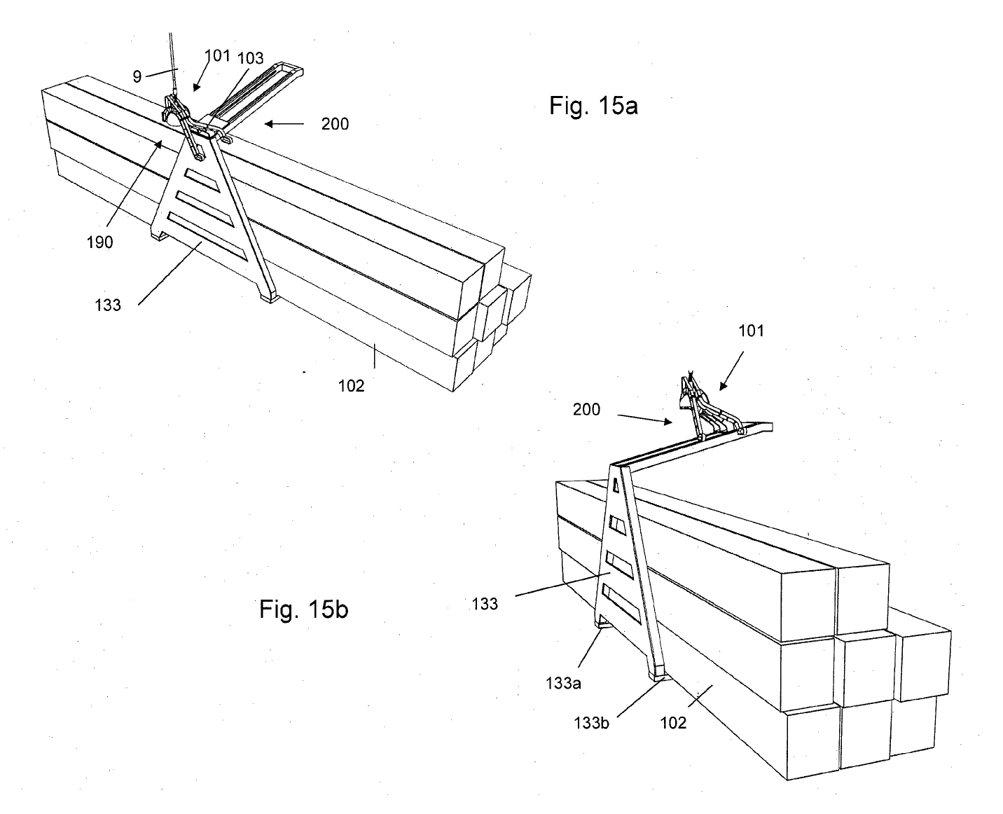

FIGS. 15a and 15b illustrate the principle of the present invention used for lifting a general type of load;

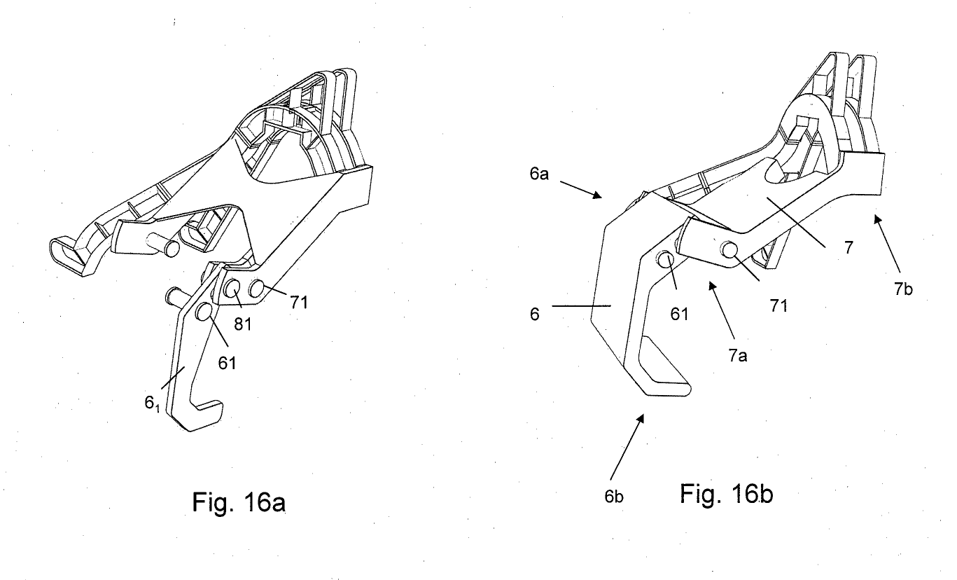

FIGS. 16a and 16b illustrate alternative embodiments of the invention.

A first embodiment of a supporting device 1 for supporting a load 2 to a structure 4 (see FIG. 8c) will be described in the following. In the first embodiment, the structure 4 is a railing 4a on the side of an offshore vessel (not shown), where the supporting device is configured to be supported on the railing 4a. A deck 4b of the vessel is also shown in FIG. 8c. The load 2 is in this embodiment a pipe or hose, having a first end connected to a fluid transfer system of an offshore platform (not shown) and a second end 2a for connection to a fluid transfer system 5 of the vessel. A crane (not shown) on the offshore platform is used to lift the supporting device with load from the platform and connect it to and from the structure of the vessel.

It should be noted that this specific application is used as an example only, and that there are several other applications where the invention described herein can be used. First of all, the crane may be located on the vessel instead of the platform. Moreover, the supporting device may be lifted from the vessel and to the platform, for connection to a structure of the platform. The invention may also be used in onshore lifting operations, helicopter lifting operations or in other suitable applications.

It is now referred to FIG. 1-3, where a supporting device 1 for supporting a load 2 to structure 4 (see FIG. 8c) is shown. The supporting device 1 comprises a body 3, a movement restraining device 6 and an actuating device 7.

It is now referred to FIG. 4a-d. Here it is shown that the body 3 comprises a first abutment surface 30a and a second abutment surface 31a, where the first and second abutment surfaces 30a, 31a are at least partially faced towards each other forming parts of a mainly U-shaped surface 32 of the body 3. The first abutment surface 30a is a part of a first leg 30 of the body 3, while the second abutment surface 31a is a part of a second leg 31 of the body 3.

In the present invention, the body 3 is normally oriented to that the legs 30, 31 are protruding substantially in a direction downwardly. As shown in FIG. 8c, the U-shaped surface 32 is configured to be inserted over a railing 4a or other type of structure 4. It should be noted that the legs 30, 31 with abutment surfaces 30a, 31a may have a general design configured for support to different types of structures, or they may have a specific design configured for support to a specific type of structure.

The body 3 further comprises a load supporting device 33 for supporting the load 2 in relation to the body 3. In FIG. 9, it is shown that the body comprises three load supporting devices 33a, 33b, 33c for supporting the hose 2 in relation to the body 3. It should be noted that in this embodiment, the hose 2 comprises a swivel arrangement 2b (see FIG. 4c) for allowing rotation of the hose with respect to its second end 2a. The load supporting devices 33 are provided for supporting the swivel arrangement 2b and the hose 2 to the body 3 while still allow such rotation.

Moreover, the hose may comprise a so-called weak link 2c comprising a built in outflow prevention. According to this, the hose will break at the weak link 2c if heavily strained, and leakage of fluid is prevented due to the outflow prevention.

In FIG. 4c it is also shown that the second end 2a of the hose 2 is generally U-shaped, since this may simplify the connection of the hose 2 to the fluid transfer system 5. The supporting device 1 is designed for such a U-shaped hose, and for protection of this part of the hose as will be apparent from the description below. Moreover, the body comprises a protection bow 36 for protection of the end 2a of the hose towards impacts etc.

It is now referred to FIG. 6a, 6b and FIG. 7.

The movement restraining device 6 is movably connected to the body 3 between a locked position shown in FIG. 8a and an unlocked position shown in FIG. 8b. The movement restraining device 6 is configured to restrain the movement of the body 3 in relation to the structure in its locked position, as shown in FIG. 8c, i.e. to limit or prevent the movement of the body 3 in relation to the structure. Preferably, the movement restraining device 6 will prevent relative movements entirely. However, in practical applications, a certain degree of movement will occur, and hence the purpose of the movement restraining device is to limit those movements. This will of course depend on the design of the movement restraining device and the body 3, an of course also the design of the structure which the supporting device 1 is supported to.

The movement restraining device 6 may comprises a plate device 6₁ with at least one first end area 6a, where a first section 60 of the first end area 6a is rotatably connected to the body 3 around a first axis A. The movement restraining device 6 also comprises at least one second end area 6b opposite of the first end area 6a where the second end area 6b is configured to restrain the movement of the body 3 in relation to the structure 4 in its locked position. In FIG. 8c it is shown that the first and second abutment surfaces 30a, 31a cover the upper side, the left side and the right side of a circular rim 4d of the railing 4a of the structure. The second end area 6b is further protruding in under the lower side of the rim 4d. Hence, it is not possible to lift the supporting device 1 away from the structure 4, and the supporting device 1 is thus considered to be in its locked state.

In FIG. 6b it is shown that the plate device 6₁ is substantially L-shaped or J-shaped when viewed from the side. However, as shown in FIG. 7, the movement device 6 comprises two such plate devices 6₁, 6₂ in parallel. The plate devices 6₁, 6₂ are also referred to as “first plate devices 6₁, 6₂”.

The actuating device 7 is movably connected to the body 3 and to the movement restraining device 6, for actuating the movement restraining device 6 between its locked and unlocked positions.

The actuating device 7 comprises two second plate devices 7₁, 7₂ in parallel, similar to the movement restraining device 6 described above. Each plate device comprises at least one first end area 7a, where a first section 70 of the first end area 7a is rotatably connected to the body 3 around a second axis B, parallel to the first axis A. A first cross bar 75 is fixed between the two plate devices 7₁, 7₂ of the actuating device 7.

The movement restraining device 6 and the actuating device 7 are connected to each other. A second, distal section 62 of the first end area 6a of the movement restraining device 6 and a second, distal section 72 of the first end area 7a of the actuating device 7 are rotatably connected to each other around a third axis C. The third axis C is parallel with respect to the first and second axis A, B. Moreover, while the first and second axis A, B are fixed with respect to the body 3, the third axis C is parallel displaceable with respect to the first and second axis A, B.

Also the second, distal section 62 of the first end area 6a of the movement restraining device 6 and the second, distal section 72 of the first end area 7a of the actuating device 7 are rotatably or pivotally connected to the body 3, i.e. they are rotably connected and at the same time parallel displaceable with respect to the body. This will be apparent from the description below.

In the present embodiment, shafts are used to connect the body with the movement restraining device 6 and the actuating device 7.

In FIG. 7 it is shown that the first section 60 of the first end area 6a of the movement restraining device 6 is rotatably connected to the body 3 by means of a first shaft 61 and the first section 70 of the first end area 7a of the actuating device 7 is rotatably connected to the body 3 by means of a second shaft 71.

Moreover, the second, distal section 62 of the movement restraining device 6 and the second, distal section 72 of the actuating device 7 comprise openings 62a, 72a respectively for connection to a third shaft 81, where at least one of the openings 62a, 72a (in FIG. 6b it is the opening 62a) is larger than the outer diameter of the third shaft 81 for allowing the parallel displacement of the third shaft 81.

The first shaft 61 and the second shaft 71 are connected to walls 34 protruding in the opposite direction of the legs 30, 31 forming the U-shaped surface 32 of the body 3. In FIGS. 4d and 5d it is shown that the walls 34 are protruding substantially upwardly from the body 3.

In the walls 34, shaft supporting devices are provided. The shaft supporting devices comprises first cylinders 38 for supporting the first shaft 61 and second cylinders 39 for supporting the second shaft 71. The cylinders 38, 39 are incorporated in the respective walls 34, as shown in FIG. 5d. The third shaft is provided in an opening 40 in the walls 34 of the body 3. The opening 40 is also larger than the outer diameter of the third shaft 81, for allowing the parallel displacement of the third shaft 81.

It should be noted that the body 3 also may comprise stopping means 41, for stopping or limiting the movement of the actuating device 7 and hence also the movement restraining device 6. The stopping means 41 is in the present embodiment provided as a cylindrical bar fixed between the walls 34, substantially below the opening 40 as shown in FIG. 4d.

The actuating device 7 further comprises at least one second end area 7b. A movement of the second end 7b in a direction D1 away from the legs 30, 31 of the U-shaped surface 32 provides that the movement restraining device 6 is moved towards its unlocked position (from FIG. 8a to FIG. 8b). A movement of the second end 7b in a direction D2 towards the legs 30, 31 of the U-shaped surface 32 provides that the movement restraining device 6 is moved to its locked position (from FIG. 8b to FIG. 8a). As described above with reference to FIG. 8c, this will prevent the device 1 from being removed from the structure 4.

It is now referred to FIG. 4b, 5b and FIG. 7. A connection interface 90 is provided in the second end area 7b of the actuating device 7. More precisely, the connection interface is connected to the second end areas 7b of the two plate devices 7₁ and 7₂ of the actuating device 7. The connection interface 90 is configured to be engaged with a remotely controlled actuator 9.

The connection interface 90 is configured such that the device 1 may be lifted on and off the structure and to operate the actuating device 7 between its locked and unlocked position by means of the remotely controlled actuator 9. Hence, no manual work is needed during these operations. This will be explained in detail below.

First, the remotely controlled actuator 9 will be described with reference to FIG. 11. The remotely controlled actuator 9 comprises a first stopping device 9a, a first actuator element 9b and a second stopping device 9c. The first stopping device 9a is provided in the end of the actuator 9, has a substantially hemispherical shape and is made of a shock absorbing material for avoiding damage to the structure 4. The first actuator element 9b may be flexible or rigid, and may comprise a chain, a chain enclosed in a plastic material, an elongated pipe etc. There may be a flexible link between the first stopping device 9a and the actuator element 9b. The second stopping device 9c is provided as a ball etc having a diameter larger than the diameter of the actuator element 9b but less than the diameter of the first stopping device 9a. The second stopping device is connected to a wire 9d of a lifting device, such a as a crane or helicopter etc. It should be noted that the remotely controlled actuator is not a part of the present invention. Moreover, there may be several types of actuators that may be suitable for connection to the connection interface 90 and/or for actuating the actuating device 7. Note however, that the remotely controlled actuator 9 is here controlled by movement of the wire 9d by means of the lifting device. In this context, the lifting device is considered to be located remotely in relation to the supporting device 1. The remotely controlled actuator 9 may also be considered to be a wire controlled actuator.

A first, substantially U-shaped cross member 76 is provided between the respective second end areas 7b of the two plate devices 7₁ and 7₂ of the actuating device 7. The U-shaped cross member 76 together with the cross bar 75 is providing that the two plate devices 7₁ and 7₂ are held in parallel. A bar 78 may be provided between the cross bar 75 and the U-shaped cross member 76 for further reinforcement of the actuating device 7.

A second U-shaped cross member 77 is provided in parallel to the first U-shaped cross member 76. The second U-shaped cross member 77 is fixed to the second end area 7b of the second plate device 7₂ of the actuating device 7 and to the bar 78. It should be noted that there is a distance between the first and the second U-shaped cross member 76, 77, forming a slot 79 having an opening 79a. The slot 79 is substantially perpendicular to the plate devices 7₁, 7₂. It should be noted that due to the opening 79a, the second end 7b of the plate devices 7₁, 7₂ are not identical. This is apparent in FIG. 5b. As will be apparent from the description below, the bar 78 protrudes into the slot 79a and forms a stop for the remotely controlled actuator 9. The connection interface 90 comprises first and second rails 91, 92 configured for receiving the first actuator element 9b of the remotely controlled actuator 9 between the first and second rails 91, 92. In the present embodiment, the first rail 91 is provided on the second U-shaped cross member 77, while the second rail 92 is provided on the first U-shaped cross member 76, as shown in FIG. 7. In FIG. 9 it is shown that the rails 91, 92 are declining with an angle α in relation to the horizontal axis towards the opening 79a.

The device 1 further comprises at least one guiding device for guiding the remotely controlled actuator 9 towards the connection interface 90. The at least one guiding device may be connected to the body 3 or to other parts of the device 1. In the present embodiment, the device 1 comprises a first guiding device 93 connected to the first rail 91 and a second guiding device 94 connected to the second rail 92. As shown in FIGS. 4b and 5b, the first guiding device 93 is an elongation of the second substantially U-shaped cross member 77, while the second guiding device 94 is an elongation of the first substantially U-shaped cross member 76. Hence, the at least one guiding means is connected to the actuating device 7.

The first guiding device 93 is a substantially straight extension of the cross member 77. The second guiding device 94 is turned towards the structure 4, and the end of the second guiding device 94 may be configured to be aligned with the structure 4, or more specific, the side surface of the railing 4a. The first and second guiding devices 93, 94 provide a guide for guiding the remotely controlled actuator towards the opening 79a of the slot 79. As is apparent from the drawings, the distance between the ends of the first and second guiding device 93, 94 is larger than the distance between the rails 91, 92.

Consequently, the actuating device 7 comprises the structure formed by the first and second plate devices 7₁ and 7₂, the first cross bar 75, cross members 76, 77 and bar 78. Moreover, also the guiding devices 93, 94 and the rails 91, 92 may be considered to be a part of the actuating device 7.

The connection interface 90 further comprises a releasable locking device 95 for releasably locking the remotely controlled actuator 9 to the connection interface 90. This will prevent undesired release of the remotely controlled actuator 9 from the connection interface. In the present embodiment, the releasable locking device 95 comprises a disk 96 having a cut-out 97 configured to convey the first actuator element 9b, where the disk 96 is rotatable between an open position (FIGS. 12a, 12c and 12d) and a closed position (FIG. 12b) when the force acting on the disk is exceeding a predetermined threshold. The releasable locking device 95 further comprises fastening means generally denoted with reference number 98 in FIG. 12c, for fastening the disk 96 to the substantially U-shaped cross member 76. The fastening means may comprise a bolt and nut connection, washers etc. As mentioned above, the fastening means allows the disk 96 to rotate in relation to the cross member 76. In FIG. 12c, the rotation axis for the disk is indicated by a dashed line.

The disk 96 comprises two circular ridges, a first ridge 96a and a second ridge 96b on its upper side of FIG. 12c. A correspondingly shaped groove is formed in the lower side of cross member 76, provided for receiving the first and second ridges of the disk when the disk rotates. In the open position the second ridge 96b is provided in the groove. Consequently, it will require a predetermined force to move the ridge out of the grove for moving the disk to its locked position. In the locked position, the first ridge 96a is provided in the grove. Consequently, it will require a predetermined force to move the ridge out of the grove for moving the disk to its open position again.

It should be noted that this type of locking of the disk could be provided with other types of mechanisms as well.

The use of the device 1 will now be described. The lifting operation is as described in the introduction above. Initially, the device 1 is carrying a load in the form of a hose 2 and is located on an offshore platform. A crane device having a remotely controlled actuator 9 connected to its lifting wire is also located on the platform.

The device 1 with the hose 2 (hose end 2a) is now to be lifted from the platform to a vessel near the platform.

It should be noted that the distance between the first and second rails 91, 92 is larger than the diameter of the first actuator element (9b) for allowing the first actuator element 9b to pass between the rails and enter into slot 79 via the opening 79a. Hence, in a first step, the first actuator element is sideways inserted into the slot 79 and into the cut-out 96 of the releasable locking device 95. By forcing the actuator 9 further into the slot 79, the releasable locking device 95 rotates from the position shown in FIG. 5b and FIG. 10 to a position where the first actuator element 9b is enclosed by the cut-out 96 and the U-shaped cross member 77 when viewed from below. During this operation, the second ridge 96b will be forced out from the groove of the cross member 76 and the disk 96 will rotate until the first ridge 96a is provided in the groove. It should be noted that a further sideways movement of the actuator past the locked position is prevented by the bar 78. See FIG. 12b.

Then, the actuator 9 is elevated until the first stopping device 9a is provided under the substantially U-shaped cross members 76, 77. The cross members 76, 77 catches the first stopping device 9a, hand when lifting the wire 9d further, also the device 1 will be lifted. During lifting, the actuating device 7 will also be lifted (this can be seen in FIG. 12), and consequently, the movement restraining device 6 will be in its unlocked state as illustrated in FIG. 8b.

The device 1 may now be lifted from the platform to the structure of the vessel and may be lowered down over the structure 4 so that the substantially U-shaped surface 32 of the body 3 is hanging over the railing 4d of the structure. Now, the abutment surface 31a is supported towards the outer side (left of FIG. 8c) of the railing, while the abutment surface 32a is supported towards the inner side (right of FIG. 8c) of the railing. The wire is now lowered further. The weight of the actuation device 7 is configured to force the movement restraining device 6 to its locked position (i.e. the weight of the second end area 7b, the weight of the cross bar 75 and cross members 76, 77, the elements of the connection interface 90 etc).

The wire is lowered further, until the second stopping device 9c runs into the top of the rails 91, 92 (see FIG. 12d). Since the distance between the first and second rails 91, 92 is smaller than the diameter of the second stopping device 9c, and the first and second rails 91, 92 are declining with an angle α with respect to a horizontal axis, the rails 91, 92 is guiding the second stopping device 9c located above the first actuator element 9b away from the body 3 and out of the opening 79a of the slot 79. The releasable locking device 95 will rotate back to the position shown in FIG. 10 and the first actuator element 9b will be released from the cut-out 76. Normally, the weight of the first stopping device 9a, the actuator element 9b and the second stopping device 9c is sufficient to force a release of the locking device 95 (i.e. to release the first ridge 96a from the groove). Alternatively, the crane operator must force the actuator 9 further away from the body 3 to ensure a release.

The crane is now free to be used for other purposes. When the device 1 is to be removed from the structure 4, the crane operator brings the actuator 9 towards the side surface of the vessel to the right of the device 1 (see FIG. 9). The shock absorbing material of the first stopping device 9a (and possibly also other parts of the actuator 9) will not scratch the surface of the vessel. Then, the crane operator moves the actuator 9 to the left, and now the actuator will slide along the side surface of the vessel until the first actuator element 9b is caught between the guiding devices 93, 94 and is guided further into the opening 79a of the slot 79. The releasable locking device 95 will again lock the first actuator element 9b to the device 1, and the actuator may be elevated for releasing the movement restraining device 6 and hence the supporting device 1 from the structure 4, as described above.

Consequently, it achieved a simplified way of engaging a remotely controlled actuator 9 to a supporting device 1. It should be noted that the side surface of the vessel to the right of the supporting device 1 may be from a couple of meters to several tens of meters, depending on the location of the structure 4. Moreover, the length of the first actuator element 9b may be several meters long. Hence, the crane operator has rather large tolerances when trying to engage the remotely controlled actuator 9 to the connection interface 90 of the supporting device 1. It would also be possible to perform such an engagement under bad weather conditions with relative movement between the vessel and the remotely controlled actuator 9.

### Second Embodiment

A second embodiment of the invention will now be described with reference to FIGS. 13a and 13b. The supporting device 1 for supporting a load to a structure also here comprises a body 3 with a U-shaped surface 32 substantially as described above, a movement restraining device 6 as described above and an actuation device 7 as described above. Moreover, a connection interface 90 is provided in the second end 7a of the actuation device 7 in similar way as described above.

In the second embodiment, the load 2 comprises a number of pipe sections. The body comprises a load supporting device 33 for supporting the load 2 to the body 3. It should be noted that also the body 3 may have a different design especially configured for this type of load and load supporting device 33.

As shown in FIG. 13b, the operator may control the remotely controlled actuator to slide along the side surface of the pipes until the first actuator element 9b is caught between the guiding devices 93, 94 and is guided further into the opening 79a of the slot 79.

### Third Embodiment

It is now referred to FIGS. 14a and 14b. According to the present invention, a supporting device 101 for supporting a load 102 is shown. The supporting device 101 comprises a body 103 comprising a load supporting device 133 for supporting the load 102 in relation to the body 103 and a connection interface 190 fastened to the body 103. The connection interface 190 is configured to be engaged with a remotely controlled actuator 9. In the present embodiment, the load 102 is a container known for a skilled person. Moreover, the load supporting device 133 is a frame for releasable connection to the container. It should be noted that in the present embodiment, most of the body 103 is constituted by the load supporting device 133. The load supporting device 133 would here also be considered known for a skilled person.

The connection interface 190 corresponds to the connection interface 90 of the first and second embodiments described above. In the description below, all reference numbers corresponds in similar way to the corresponding elements for the first and second embodiments described above. The connection interface 190 comprises first and second rails 191, 192 configured for receiving a first actuator element 109b of the remotely controlled actuator 9 between the first and second rails 191, 192.

The distance between the first and second rails 191, 192 is larger than the diameter of the first actuator element 9b for allowing the first actuator element to pass between the rails, and where the distance between the first and second rails 191, 192 is smaller than the diameter of a first stopping device 9a located below the first actuator element 9b of the remotely controlled actuator 9.

The first and second rails 191, 192 is also here declining with an angle α with respect to a horizontal axis for guiding a second stopping device 9c located above the first actuator element 9b of the remotely controlled actuator 9 away from the body 103.

The connection interface 190 further comprises a releasable locking device 195 for releasably locking the remotely controlled actuator 9 to the connection interface 190.

The releasable locking device 195 comprises a disk having a cut-out 196 configured to convey the first actuator element 9b, where the disk is rotatable between an open position and a closed position when the force acting on the disk is exceeding a predetermined threshold.

The device 101 further comprises at least one guiding device for guiding the remotely controlled actuator 9 towards the connection interface 90. For example, the device 101 may comprise a first guiding device 193 connected to the first rail. 191 and a second guiding device 194 connected to the second rail 192.

The device 101 may further comprise a load balancing device 200 for balancing the load in relation to the connection interface 190 during a lifting operation. In the present embodiment, the load balancing device 200 is provided as a part of the body 103 and provides that the connection interface 190 is in an initial position before and after the lifting operation, where the second guiding device 194 is configured to be aligned with the load 102 in the initial position. The load balancing device also provides that the connection interface 190 is in a central position over the load 102 during the lifting operation.

In the present embodiment, the load balancing device comprises a sliding device 201 fixed between the load supporting device 133 and the body 103 for allowing a sliding movement of the body 103 in relation to the load supporting device 133 between the initial position and the central position.

### Fourth Embodiment

It is now referred to FIGS. 15a and 15b, illustrating a fourth embodiment similar to the third embodiment. According to the present invention, a supporting device 101 for supporting a load 102 is shown. The supporting device 101 comprises a body 103 comprising a load supporting device 133 for supporting the load 102 in relation to the body 103 and a connection interface 190 fastened to the body 103. The connection interface 190 is configured to be engaged with a remotely controlled actuator 9.

In the present embodiment, the load 102 is a general load, for example bars, beams or other types of elongated objects. The load may also be other types of load. Moreover, the load supporting device 133 is also here a type of frame comprising two lower, substantially horizontal forks 133a, 133b. The forks may for example be suitable for lifting pallets.

The connection interface 190 corresponds to the connection interface of the third embodiment described above, and will not be described here in detail. As shown in FIGS. 15a and 15b, also the fourth embodiment comprises a load balancing device 200 for balancing the load in relation to the connection interface 190 during a lifting operation.

### Alternative Embodiments

There are several ways to implement the embodiments described above. For example, the first, second and third shafts of embodiment 1 and 2 may be replaced with other connection means allowing rotation of the movement restraining device 6 and the actuating device 7 to rotate with respect to each other and with respect to the body 3. Such an alternative is illustrated in the embodiment shown in FIG. 16a, where connection means 61, 71, 81 in the form of bolts are used. It should also be noted that in FIG. 16a, the movement restraining device 6 only comprises one plate device.

It should be noted that the movement restraining device 6 and the actuating device 7 do not need to comprise parallel plate devices 6₁ and 6₂, and 7₁ and 7₂ respectively. The configuration with parallel plate devices is especially suitable for providing a protective space for the hose. However, for other types of loads, the configuration with parallel plate devices is not necessary. In FIG. 16b, the movement restraining device 6 is provided as one body, where a cross sectional side view of the body has similar shape as a side view of one of the plate devices in the first embodiment. In FIG. 16b the movement restraining device comprises one first end area 6a, and one second end area 6b opposite of the first end area 6a. The first and second ends are similar to the respective ends of the plate devices described above.

In similar way, the actuating device 7 may also be provided as a body having one or two protruding parts for rotable connection to the movement restraining device, where the cross sectional side view of the body has similar shape as a side view of one of the plate devices in the first embodiment. In FIG. 16b, the actuating device 7 comprises one first end area 7a and one second end area 7b. Since the actuating device here is provided as one body, no cross bar 75 or bar 78 is needed to strengthen the structure of the actuating device.

Moreover, it should be noted that the embodiments above may be used for lifting several other types of loads, where the body 3 may be adapted to the type of load and/or to the structure.

The present invention may be used for all applications where there is a need to move a hanging load, and where there are pendulum movements, and/or relative movement between the initial location and the target location.

1. Supporting device for supporting a load (2) to a structure (4), comprising:
a body (3) comprising a first abutment surface (30a) and a second abutment surface (31a), where the first and second abutment surfaces (30a, 31a) are at least partially faced towards each other forming parts of a mainly U-shaped surface (32) of the body (3), where the body (3) further comprises a load supporting device (33) for supporting the load (2) in relation to the body (3);
a movement restraining device (6) movably connected to the body (3) between a locked and unlocked position, wherein the movement restraining device (6) is configured to restrain the movement of the body (3) in relation to structure in its locked position;
an actuating device (7) comprising a first end area (7a) and a second end area (7b) opposite of the first end area (7a), where the first end area (7a) is movably connected to the body (3) and to the movement restraining device (6), for actuating the movement restraining device (6) between its locked and unlocked positions;
a connection interface (90) provided in the second end area (7b) of the actuating device (7), where the connection interface (90) is configured to be engaged with a remotely controlled actuator (9).

2. Device according to claim 1, where the movement restraining device (6) comprises at least one first end area (6a), where a first section (60) of the first end area (6b) is rotatably connected to the body (3) around a first axis (A).

3. Device according to claim 2, where the movement restraining device (6) comprises at least one second end area (6b), opposite of the first end area (6a), where the second end area (6b) is configured to restrain the movement of the body (3) in relation to the structure in its locked position.

4. Device according to claim 3, where a first section (70) of the first end area (7a) of the actuating device (7) is rotatably connected to the body (3) around a second axis (B), parallel to the first axis (A).

5. Device according to claim 4, where a second, distal section (62) of the first end area (6a) of the movement restraining device (6) and a second, distal section (72) of the first end area (7a) of the actuating device (7) are rotatably connected to each other around a third axis (C), where the third axis (C) is parallel displaceable with respect to the first and second axis (A, B).

6. Device according to claim 1, where movement of the second end (7b) of the actuating device (7) in a direction (D1) away from the legs (30, 31) of the U-shaped surface (32) provides that the movement restraining device (6) is moved to its unlocked position and where a movement of the second end (7b) of the actuating device (7) in a direction (D2) towards the legs (30, 31) of the U-shaped surface (32) provides that the movement restraining device (6) is moved to its locked position.

7. Device according to claim 1, where the connection interface (90) comprises first and second rails (91, 92) configured for receiving a first actuator element (9b) of the remotely controlled actuator (9) between the first and second rails (91, 92).

8. Device according to claim 1, where the connection interface (90) further comprises a releasable locking device (95) for releasably locking the remotely controlled actuator (9) to the connection interface (90).

9. Device according to claim 1, where the device (1) further comprises at least one guiding device (93, 94) for guiding the remotely controlled actuator (9) towards the connection interface (90).

10. Device according to claim 9, where the device comprises a first guiding device (93) connected to the first rail (91) and a second guiding device (94) connected to the second rail (92).

11. Device according to claim 7, where the distance between the first and second rails (91, 92) is larger than the diameter of the first actuator element (9b) for allowing the first actuator element to pass between the rails, and where the distance between the first and second rails (91, 92) is smaller than the diameter of a first stopping device (9a) located below the first actuator element (9b) of the remotely controlled actuator (9).
